(19) United States
(12) Patent Application Publication
(10) Pub. No.: US 2004/0099433 A1
(43) Pub. Date: May 27, 2004

(54) Cable having a fixing member

(76) Inventor: Fu-Cheng Lin, Chang Hua (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/429,647

(22) Filed: May 5, 2003

(30) Foreign Application Priority Data
Nov. 26, 2002 (TW) 091219172

(51) Int. Cl. H02G 15/02

(52) U.S. Cl. 174/74 R

(57) ABSTRACT

A cable has two distal ends each provided with a fixing member. The cable includes a cable body and a coating layer. The cable body has two distal ends each protruding outward from the coating layer. The fixing member has an inside formed with a first urging hole and a second urging hole. The first urging hole is not communicated with the second urging hole. Thus, the fixing member is formed with two independent urging holes to closely press and clamp the coating layer and the cable body of the cable respectively, thereby enhancing the tensile strength of the cable.

### BACKGROUND OF THE INVENTION

1. Field of the Invention

The present invention relates to a cable having a fixing member, and more particularly to a cable having a fixing member, wherein the fixing member is formed with two independent urging holes to closely press and clamp the coating layer and the cable body of the cable respectively, thereby enhancing the tensile strength of the cable.

2. Description of the Related Art

A first conventional cable 20A in accordance with the prior art shown in FIGS. 1-3 has two distal ends each provided with a fixing member 10. The cable 20A includes a cable body 22A and a coating layer 21A mounted on the cable body 22A. The fixing member 10 has an inside formed with two through holes 11 communicating with each other. In assembly, referring to FIGS. 3 and 3A with reference to FIGS. 1 and 2, each of the two distal ends of the coating layer 21A of the cable 20A is initially extended through one through hole 11 of the respective fixing member 10, and then extended through the other through hole 11 of the respective fixing member 10. Then, the cable 20A and the respective fixing member 10 are punched, so that the respective fixing member 10 is fixed on the cable 20A. However, the coating layer 21A is located between the cable body 22A and the fixing member 10, so that the cable body 22A is easily detached from the fixing member 10 when the coating layer 21A is worn out during a long-term utilization, thereby decreasing the tensile strength of the cable 20A. In addition, the coating layer 21A is strongly compressed by the fixing member 10 during the punching process, so that the coating layer 21A is easily deformed or broken and the cable body 22A deviates from the central position as shown in FIG. 3A. Thus, the cable 20A and the respective fixing member 10 are not combined rigidly and stably, thereby decreasing the tensile strength of the cable 20A.

A second conventional cable 20B in accordance with the prior art shown in FIGS. 4-6 has two distal ends each provided with a fixing member 30. The cable 20B includes a cable body 22B and a coating layer 21B mounted on the cable body 22B. The cable body 22B has two distal ends each protruding outward from the coating layer 21B. The fixing member 30 has an inside formed with two through holes 31 communicating with each other. In assembly, referring to FIGS. 6 and 6A with reference to FIGS. 4 and 5, each distal end of the coating layer 21B of the cable 20B is initially extended through one through hole 31 of the respective fixing member 30, and each distal end of the cable body 22B of the cable 20B is then extended through the other through hole 31 of the respective fixing member 30. Then, the cable 20B and the respective fixing member 30 are punched, so that the respective fixing member 30 is fixed on the cable 20B. However, the two through holes 31 communicating with each other. Thus, the coating layer 21B is strongly compressed by the fixing member 30 during the punching process, so that the coating layer 21B is easily deformed or broken and the cable body 22B deviates from the central position as shown in FIG. 6A. Thus, the cable 20B and the respective fixing member 30 are not combined rigidly and stably, thereby decreasing the tensile strength of the cable 20B.

### SUMMARY OF THE INVENTION

The present invention is to mitigate and/or obviate the disadvantage of the conventional cable.

The primary objective of the present invention is to provide a cable having a fixing member, wherein the fixing member is formed with two independent urging holes to closely press and clamp the coating layer and the cable body of the cable respectively, thereby enhancing the tensile strength of the cable.

Another objective of the present invention is to provide a cable having a fixing member, wherein the whole periphery of the coating layer of the cable is closely clamped by the first urging hole of the respective fixing member, and the whole periphery of the cable body of the cable is closely clamped by the second urging hole of the respective fixing member, so that the cable is combined with the respective fixing member rigidly and stably without detachment, thereby enhancing the tensile strength of the cable.

In accordance with the present invention, there is provided a cable having a fixing member, comprising having two distal ends each provided with a fixing member, wherein:

the cable includes a cable body and a coating layer mounted on the cable body, the cable body has two distal ends each protruding outward from the coating layer; and

the fixing member has an inside formed with a first urging hole and a second urging hole, the first urging hole is not communicated with the second urging hole.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a first conventional cable in accordance with the prior art;

FIG. 2 is a perspective assembly view of the first conventional cable in accordance with the prior art;

FIG. 3 is a cross-sectional view of the first conventional cable as shown in FIG. 2;

FIG. 3A is a schematic operational view of the first conventional cable as shown in FIG. 3;

FIG. 4 is an exploded perspective view of a second conventional cable in accordance with the prior art;

FIG. 5 is a perspective assembly view of the second conventional cable in accordance with the prior art;

FIG. 6 is a cross-sectional view of the second conventional cable as shown in FIG. 5;

FIG. 6A is a schematic operational view of the second conventional cable as shown in FIG. 6;

FIG. 7 is an exploded perspective view of a cable having a fixing member in accordance with the preferred embodiment of the present invention;

FIG. 8 is a perspective assembly view of the cable having a fixing member in accordance with the preferred embodiment of the present invention;

FIG. 9 is a cross-sectional view of the cable having a fixing member as shown in FIG. 8;

FIG. 9A is a schematic operational view of the cable having a fixing member as shown in FIG. 9.

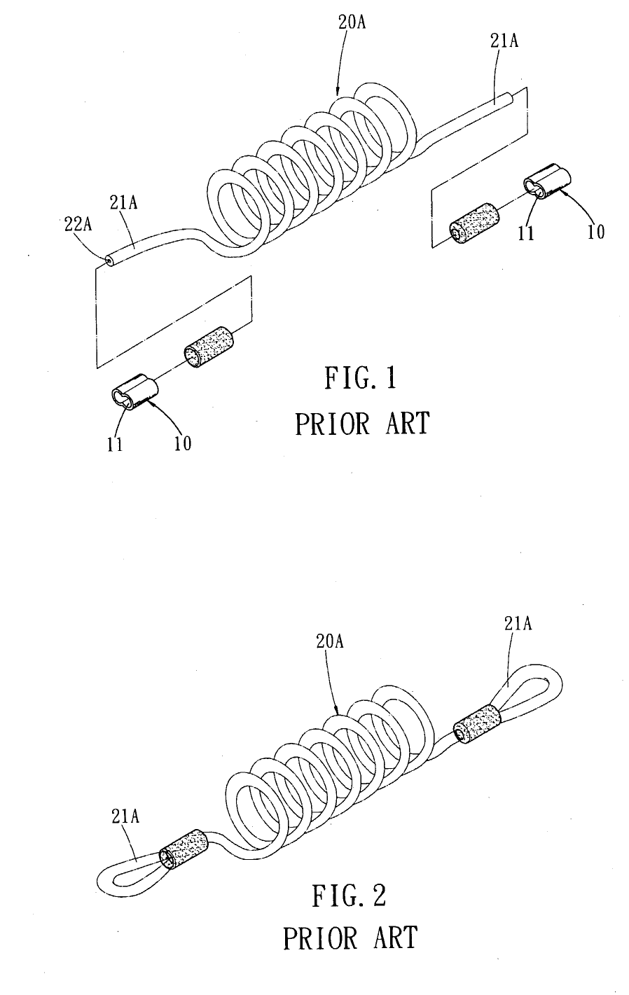

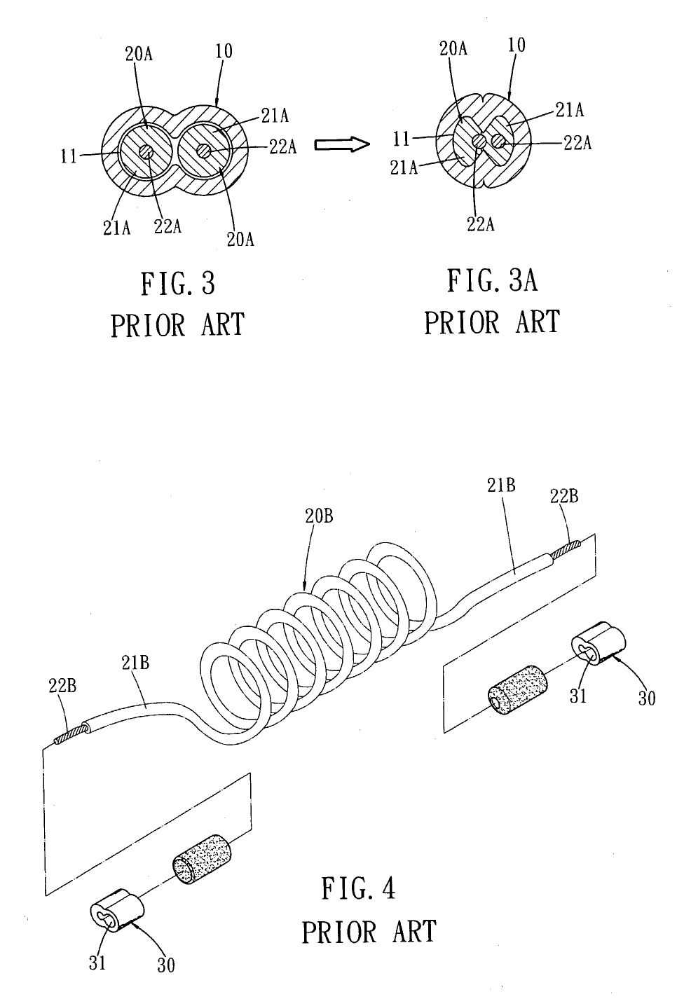

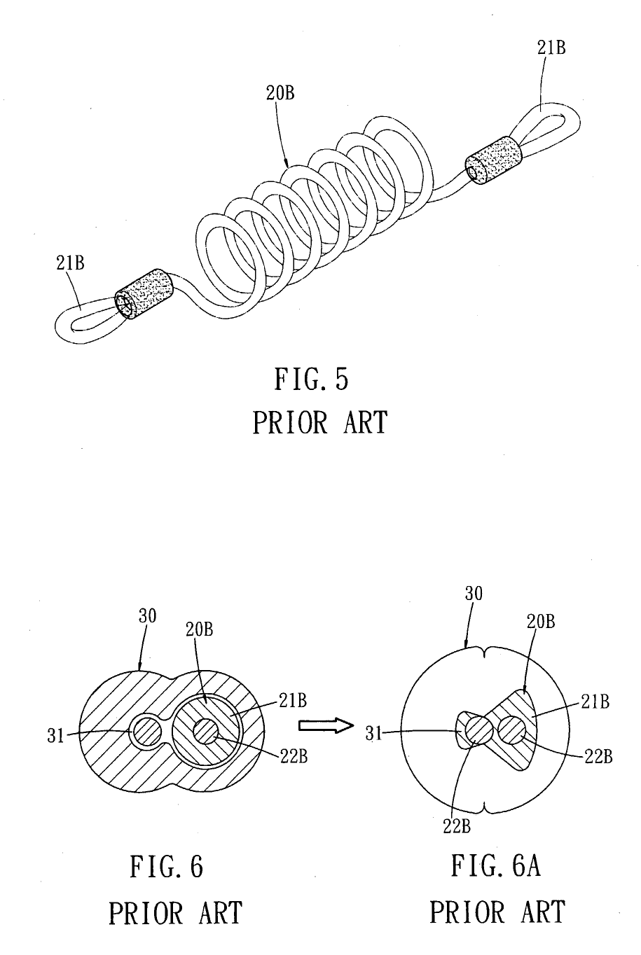

### DETAILED DESCRIPTION OF THE INVENTION

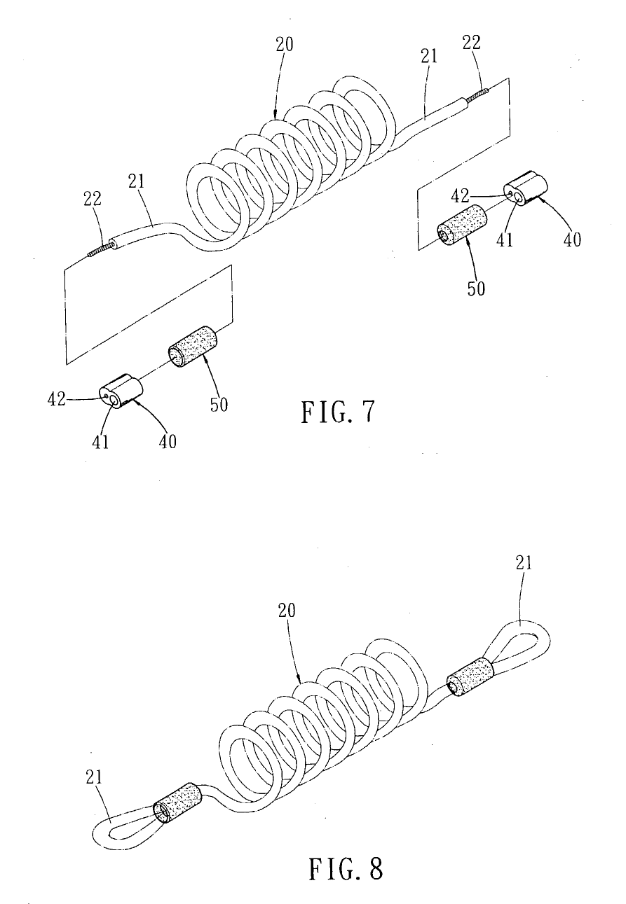

Referring to the drawings and initially to FIGS. 7 and 8, a cable 20 having a fixing member in accordance with the preferred embodiment of the present invention has two distal ends each provided with a fixing member 40 and a rubber sleeve 50 encompassing the fixing member 40.

The cable 20 includes a cable body 22 and a coating layer 21 made of PU mounted on the cable body 22. The cable body 22 has a length greater than that of the coating layer 21. The cable body 22 has two distal ends each protruding outward from the coating layer 21.

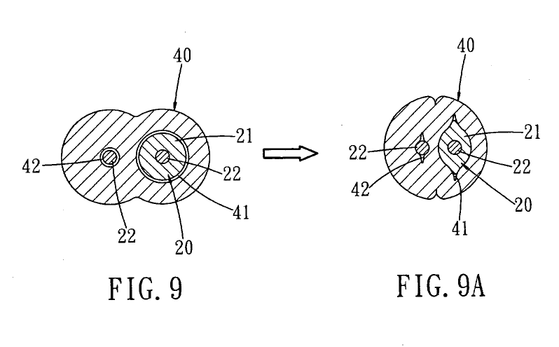

The fixing member 40 has a substantially “8”-shaped cross-section as shown in FIG. 9. The fixing member 40 has an inside formed with a first urging hole 41 and a second urging hole 42. The first urging hole 41 is not communicated with the second urging hole 42. The first urging hole 41 has a diameter smaller than that of the second urging hole 42.

In assembly, referring to FIGS. 9 and 9A with reference to FIGS. 7 and 8, each of the two distal ends of the cable body 22 of the cable 20 is initially extended through the first urging hole 41 of the respective fixing member 40, with the coating layer 21 of the cable 20 being mounted in the first urging hole 41 of the respective fixing member 40, and is then inserted into the second urging hole 42 of the respective fixing member 40. Then, the cable 20 and the respective fixing member 40 are processed by a punching procedure, so that the respective fixing member 40 is fixed on the cable 20. At this time, the whole periphery of the coating layer 21 of the cable 20 is closely clamped by the first urging hole 41 of the respective fixing member 40, and the whole periphery of the cable body 22 of the cable 20 is closely clamped by the second urging hole 42 of the respective fixing member 40 as shown in FIG. 9A. Then, the rubber sleeve 50 is mounted on the respective fixing member 40, thereby assembling the whole cable 20.

Accordingly, after the fixing member 40 is processed by the punching procedure, the whole periphery of the coating layer 21 of the cable 20 is closely clamped by the first urging hole 41 of the respective fixing member 40, and the whole periphery of the cable body 22 of the cable 20 is closely clamped by the second urging hole 42 of the respective fixing member 40, so that the cable 20 is combined with the respective fixing member 40 rigidly and stably without detachment, thereby enhancing the tensile strength of the cable 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A cable having a fixing member, comprising having two distal ends each provided with a fixing member, wherein:
the cable includes a cable body and a coating layer mounted on the cable body, the cable body has two distal ends each protruding outward from the coating layer; and
the fixing member has an inside formed with a first urging hole and a second urging hole, the first urging hole is not communicated with the second urging hole.

2. The cable having a fixing member in accordance with claim 1, wherein the fixing member has a substantially “8”-shaped cross-section.

3. The cable having a fixing member in accordance with claim 1, wherein the first urging hole has a diameter smaller than that of the second urging hole.

4. The cable having a fixing member in accordance with claim 1, wherein the coating layer of the cable is clamped in the first urging hole of the respective fixing member.

5. The cable having a fixing member in accordance with claim 1, wherein the whole periphery of the coating layer of the cable is clamped by the first urging hole of the respective fixing member.

6. The cable having a fixing member in accordance with claim 1, wherein each of the two distal ends of the cable body of the cable is clamped in the second urging hole of the respective fixing member.

7. The cable having a fixing member in accordance with claim 1, wherein the whole periphery of each of the two distal ends of the cable body of the cable is clamped in the second urging hole of the respective fixing member.
